(19) United States
(12) Patent Application Publication
(10) Pub. No.: US 2006/0239825 A1
(43) Pub. Date: Oct. 26, 2006

(54) Bi-cast blade ring for multi-alloy turbine rotor

(75) Inventors: Derek A. Rice, Phoenix, AZ (US); William C. Baker, Phoenix, AZ (US); James S. Perron, Fountain Hills, AZ (US)

Correspondence Address: Honeywell International, Inc.;Law Dept. AB2, P.O. Box 2245, Morristown, NJ, 07962-9806, US

(73) Assignee: Honeywell International Inc., Morristown, NJ (US)

(21) Appl. No.: 11/111,530

(22) Filed: Apr. 21, 2005

(51) Int. Cl. F03B 3/12

(52) U.S. Cl. 416/241 R

(57) ABSTRACT

A method for bi-casting a turbine rotor may include applying an oxidation resistant coating to individually cast rotor blades, and bi-casting the coated blades into a dual alloy blade ring, wherein the oxidation resistant coating prevents formation of an oxide scale on the surface of the rotor blades during bi-casting and allows diffusion bonding of the rotor blades to the blade ring. The oxidation resistant coating may comprise a platinum group metal or alloy thereof.

### BACKGROUND OF THE INVENTION

The present invention relates generally to turbine components and methods for forming a turbine rotor having a diffusion bonded integral blade ring.

Prior art dual alloy turbine rotors for gas turbine engines have primarily used equiaxed superalloy airfoils. Although single crystal superalloys offer superior high temperature creep strength, it is technically difficult to cast single crystal blade rings for dual alloy turbine rotors. In the past, attempts have been made to cast single crystal dual alloy turbine rotors via radial solidification. These attempts have been abandoned because of the difficulty to produce a radial thermal gradient in the blade ring during solidification. Other attempts may have been made to bi-cast blades into an inner and outer shroud (or rim). However, an oxide scale, formed on the blades during the casting process, prevents diffusion bonding between the blade and the shroud(s).

Attempts have been made in the prior art, for example, U.S. Pat. No. 5,290,143 to Kington, to bi-cast airfoils into at least one of an inner shroud and an outer shroud. However, in the prior art process an oxide scale, e.g., formed during bi-casting, prevents diffusion bonding between the blade and shrouds. The ensuing absence of a metallurgical bond between the blade and shrouds may be advantageous in the case of a stator vane, as disclosed by Kington, but is disadvantageous in the case of a rotor blade.

US Patent Application Publication No. 20050025613 (Strangman) discloses a cast integral blade ring having single crystal airfoils, wherein the blade ring is formed en masse in a single casting process using axial solidification. The viability of production by such axial solidification may rely on relaxed requirements of cast components or production yields significantly above typically attainable production yields (presently about 95%).

As can be seen, there is a need for improved apparatus and methods for forming multi-alloy turbine components.

### SUMMARY OF THE INVENTION

In one aspect of the present invention, a method for providing a turbine rotor comprises forming a plurality of individual rotor blades; forming an oxidation resistant coating on at least a portion of each of the rotor blades to provide a plurality of coated rotor blades; and bi-casting the coated rotor blades into a blade ring.

In another aspect of the present invention, there is provided a method for providing a turbine rotor comprising casting a plurality of individual rotor blades; coating at least a portion of each of the rotor blades with an oxidation resistant coating to provide a plurality of coated blades; bi-casting the coated blades into at least an inner rim to form an integral blade ring; and diffusion bonding the coated blades to at least the inner rim, wherein the coating step prevents formation of an oxide scale on a surface of the coated blades.

In yet another aspect of the present invention, a method for bi-casting a multi-alloy turbine rotor comprises casting a plurality of individual single crystal rotor blades; coating at least a portion of a surface of each of the rotor blades with an oxidation resistant coating to provide a plurality of coated blades; bi-casting the coated blades into an integral blade ring; diffusion bonding the rotor blades to at least an inner rim of the blade ring; match-machining the blade ring and an alloy disc; and diffusion bonding the blade ring to the disc to provide the multi-alloy turbine rotor. Prior to and during the bi-casting step, the oxidation resistant coating prevents formation of an oxide scale on the surface of the coated blades thereby allowing diffusion bonding of the coated blades to at least the inner rim of the blade ring. The oxidation resistant coating comprises a platinum group metal.

In still another aspect of the present invention, there is provided a method for bi-casting a multi-alloy turbine rotor comprising casting a plurality of individual single crystal rotor blades from a nickel-based superalloy; coating at least a portion of a surface of each of the rotor blades with an oxidation resistant coating to provide a plurality of coated blades; bi-casting the coated blades into at least an inner rim to provide a blade ring; diffusion bonding the coated blades to the blade ring by hot isostatic pressing, wherein prior to and during the bi-casting step, the oxidation resistant coating prevents formation of an oxide scale on the surface of the coated blades, thereby allowing diffusion bonding of the coated blades to at least the inner rim of the blade ring; providing an alloy disc; match-machining the blade ring and the disc; and diffusion bonding the rotor blades and the inner rim to the disc by hot isostatic pressing to provide the multi-alloy turbine rotor. During at least one of the diffusion bonding steps, at least a portion of the oxidation resistant coating diffuses into at least one component selected from: the rotor blades, the inner rim, and the disc. The oxidation resistant coating comprises at least one material such as platinum, palladium, rhodium, ruthenium, osmium, and iridium.

In a further aspect of the present invention, there is provided a turbine rotor prepared by a process comprising casting a plurality of individual single crystal rotor blades; coating at least a portion of the surface of each of the rotor blades with an oxidation resistant coating to provide a plurality of coated blades; bi-casting the coated blades into a blade ring comprising an inner rim; diffusion bonding the rotor blades to the inner rim of the blade ring; and diffusion bonding the blade ring to an alloy disc to provide the turbine rotor.

These and other features, aspects, and advantages of the present invention will become better understood with reference to the following drawings, description, and claims.

### BRIEF DESCRIPTION OF THE DRAWINGS

FIG. 1A is an axial view of a blade ring for a turbine rotor, according to the instant invention;

FIG. 1B is an axial view of a turbine rotor including a blade ring and a disc, according to the instant invention;

FIG. 2A is a side view of a rotor blade, according to one aspect of the invention;

FIG. 2B is an enlarged sectional view of a portion of a coated rotor blade having an oxidation resistant coating thereon, according to the invention;

FIG. 3A is an enlarged axial view of a portion of a turbine rotor showing a blade tip configuration, according to an embodiment of the invention;

FIG. 3B is an enlarged axial view of a portion of a turbine rotor showing a blade tip configuration, according to another embodiment of the invention; and

FIG. 4 schematically represents a series of steps involved in a method for providing a turbine rotor, according to another embodiment of the invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention provides apparatus and methods for making turbine rotor components for gas turbine engines, which may be used in vehicles, such as fixed wing aircraft, rotorcraft, and land vehicles, as well as for industrial power generation, and the like. The methods of this invention may provide turbine rotor components comprising single crystal rotor blades. As used herein, the term “single crystal” may be used to describe a cast component, such as a rotor blade, in which the component has a single crystallographic orientation throughout at least 95% of the load bearing portions of the component, in the absence of high angle grain boundaries.

Turbine components of the invention may be formed by bi-casting individually cast rotor blades into a blade ring, and diffusion bonding the rotor blades to at least one other component of the blade ring and/or to a rotor disc, wherein at least a portion of each rotor blade may be coated with an oxidation resistant coating prior to diffusion bonding the rotor blades to the blade ring. The oxidation resistant coating may prevent oxide scale formation on the rotor blade surface, thereby allowing diffusion bonding of the rotor blades to the blade ring. According to the invention, individually cast rotor blades may be inspected, and any sub-standard rotor blades may be eliminated prior to bi-casting the rotor blades into the blade ring. The individually cast rotor blades may be single crystal blades comprising various nickel-based superalloys. In contrast, prior art processes lack a step of applying an oxidation resistant coating to the airfoils during the manufacturing process, and/or form the bladed ring en masse in a single casting process using axial solidification of the superalloy, CMSX-486 (see, for example, US Patent Application Publication No. 20050025613). In contrast to the invention, in which the oxidation resistant coating prevents oxide scale formation on the rotor blades, in prior art processes for bi-casting turbine components, an aluminide coating applied to the airfoils results in the formation of an oxide scale during bi-casting, thereby preventing diffusion bonding between the airfoils and shrouds.

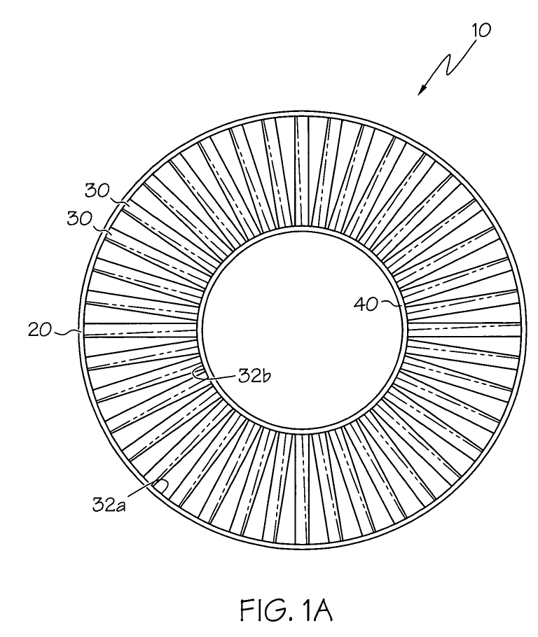

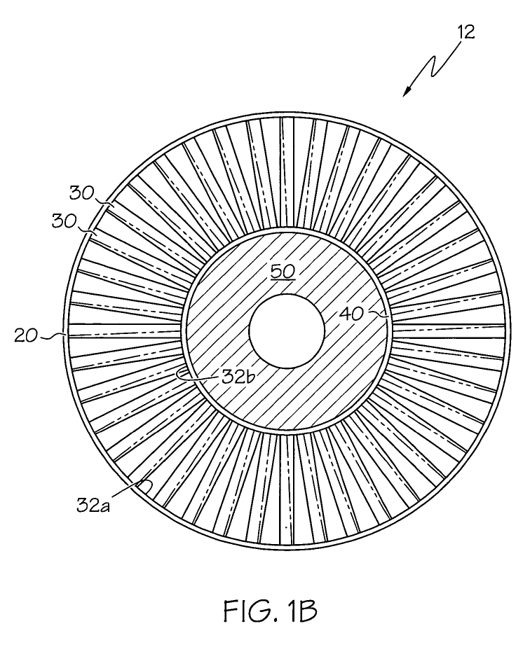

FIG. 1A is an axial view of an integral blade ring 10, according to an embodiment of the instant invention. Blade ring 10 may comprise an outer rim (or outer shroud) 20, an inner rim (or inner shroud) 40, and a plurality of rotor blades 30 extending radially inward from outer rim 20 to inner rim 40. In some embodiments, outer rim 20 may be omitted (not shown). Each rotor blades 30 may comprise a radially outer first blade tip 32a disposed within outer rim 20, and a radially inner second blade tip 32b disposed within inner rim 40.

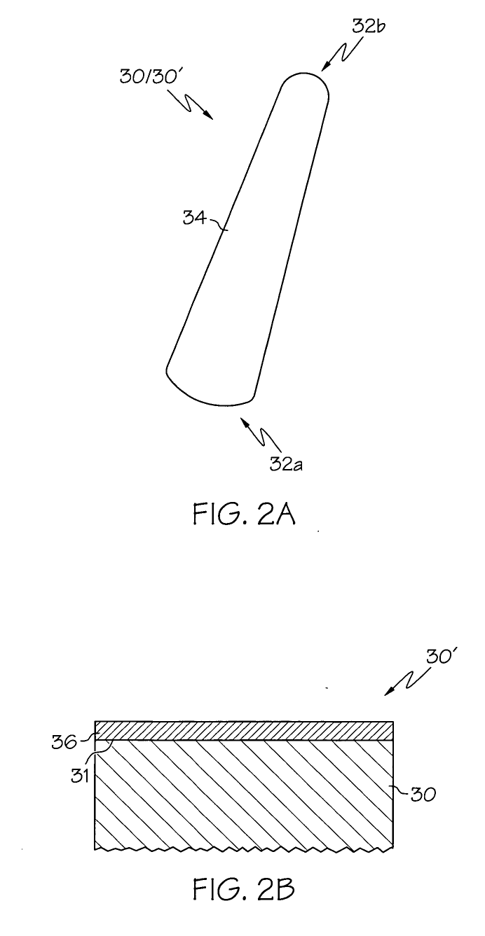

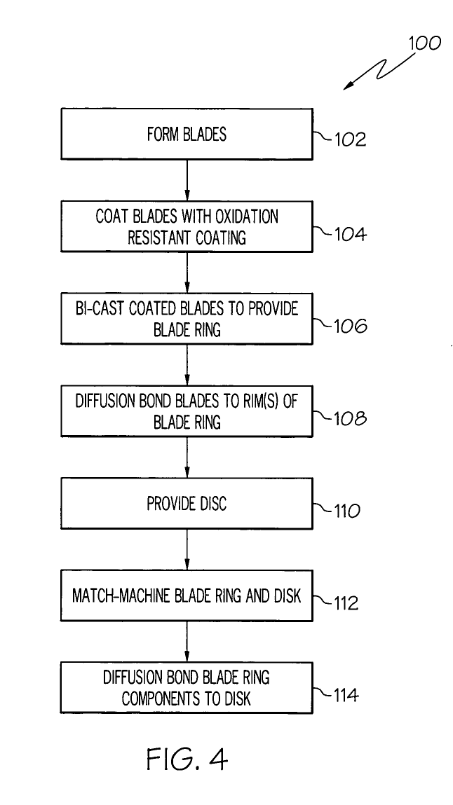

Blade ring 10 may be formed by individually casting the plurality of rotor blades 30; coating at least a portion of the surface 31 of each rotor blade 30 to provide a plurality of coated blades 30′ (see, FIG. 2B); and bi-casting the plurality of coated blades 30′ into at least inner rim 40. The coating applied to surface 31 of each rotor blade 30 may be an oxidation resistant coating 36 (see, for example, FIG. 2B), which may prevent oxide scale formation on rotor blades 30/coated blades 30′. Due to the absence of an oxide scale, rotor blades 30 may be diffusion bonded to at least inner rim 40 of blade ring 10. In some embodiments of blade ring 10 having outer rim 20, rotor blades 30 may also be diffusion bonded to outer rim 20. Such diffusion bonding of rotor blades 30 to inner rim 40 and outer rim 20 may occur initially during the bi-casting step, and thereafter further diffusion bonding may occur in a subsequent heat treatment step which may involve hot isostatic pressing (see, for example, FIG. 4). Each of outer rim 20 and inner rim 40 may comprise an equiaxed nickel-based or cobalt-based superalloy.

FIG. 1B is an axial view of a turbine rotor 12, according to another aspect of the instant invention. Turbine rotor 12 may include blade ring 10 (see, FIG. 1A) and a disc 50 disposed radially inward from blade ring 10. Turbine rotor 12 may be formed by diffusion bonding disc 50 to blade ring 10 (see, for example, FIG. 4). Disc 50 may comprise a powder metallurgy superalloy. Superalloy compositions for turbine components are generally well known in the art (see, for example, commonly assigned, co-pending US Patent Application Publication Nos. 20050047953 and 20050025613, the disclosures of which are incorporated by reference herein in their entirety).

FIG. 2A is a side view of a rotor blade 30, according to one aspect of the invention, wherein rotor blade 30 may be coated with an oxidation resistant coating 36 over at least a portion of its surface to provide a coated rotor blade 30′ (see, for example, FIG. 2B). Rotor blade 30 may have a first blade tip 32a, a second blade tip 32b, and an intermediate blade portion 34 disposed between first and second blade tips 32a, 32b. During formation of blade ring 10, first blade tip 32a may be diffusion bonded to outer rim 20, while second blade tip 32b may be diffusion bonded to inner rim 40 (see, for example, FIG. 1A).

FIG. 2B is an enlarged sectional view of a portion of coated rotor blade 30′ having oxidation resistant coating 36 disposed on surface 31 of rotor blade 30. Oxidation resistant coating 36 may be applied to surface 31 of blade 30 to prevent the formation of an oxide scale on surface 31 of rotor blade 30, thereby allowing diffusion bonding to occur between rotor blade 30 and at least one other component, e.g., inner rim 20 and/or outer rim 40, of blade ring 10.

In some embodiments of the present invention, oxidation resistant coating 36 may be applied to the entire surface of blade 30. Alternatively, in other embodiments oxidation resistant coating 36 may be selectively applied to selected regions of blade 30. As a non-limiting example, oxidation resistant coating 36 may be selectively applied to one or both of first and second blade tips 32a, 32b. Blade 30 may typically comprise a single crystal nickel-based superalloy, such as a member of the CMSX family of superalloys. In alternative embodiments, rotor blade 30 may comprise equiaxed superalloy material.

Again with reference to FIG. 2B, oxidation resistant coating 36 may comprise a platinum group metal. For example, oxidation resistant coating 36 may comprise at least one material selected from: platinum (Pt), palladium (Pd), rhodium (Rh), ruthenium (Ru), osmium (Os), and iridium (Ir). In some embodiments, oxidation resistant coating 36 may comprise platinum or a platinum alloy. Oxidation resistant coating 36 may be applied to a thickness typically up to about 0.0030 inches (ca. 12 μm), and usually up to about 0.0015 inches (ca. 6 μm). Oxidation resistant coating 36 may be applied to surface 31 of blade 30 by various deposition methods for applying coatings to turbine components, such as one or more methods selected from: electroplating, chemical vapor deposition, and ion plating. Such methods for applying coatings to turbine components are well known in the art.

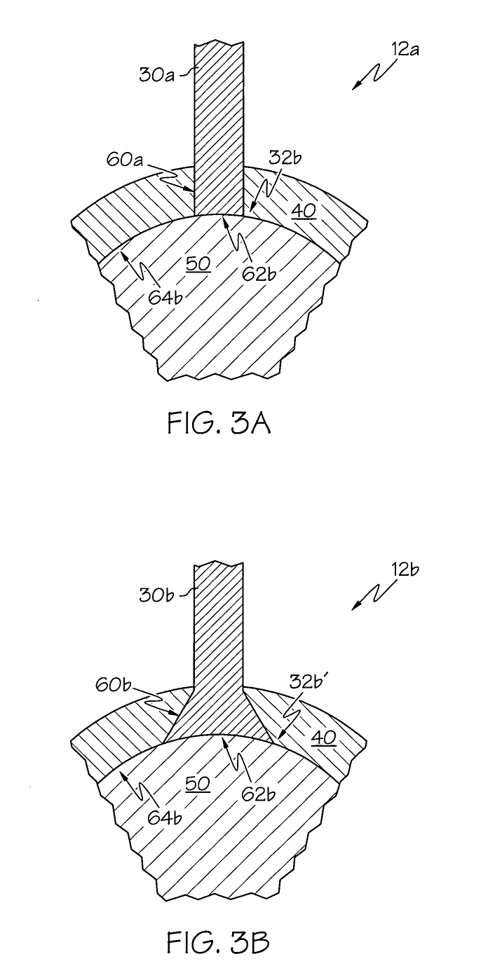

FIG. 3A is an enlarged axial view of a radially inner portion of a turbine rotor 12a showing a blade tip configuration of a blade 30a in relation to disc 50 and inner rim 40, according to an embodiment of the invention. Each of blade 30a, inner rim 40, and disc 50 may comprise a superalloy. Blade 30a may comprise a first alloy, inner rim 40 may comprise a second alloy, and disc 50 may comprise a third alloy. Each of the first, second, and third alloys may have a different composition and/or a different microstructure. As a non-limiting example, the first alloy of blade 30a may be a single crystal nickel-based superalloy, while the second alloy of inner rim 40 may comprise an equiaxed cobalt-based or nickel-based superalloy, and the third alloy may comprise a powder metallurgy superalloy. Second blade tip 32b (see, e.g., FIG. 1A) may extend radially inwards through inner rim 40 and may interface with disc 50. Thus, turbine rotor 12a may have a first interface 60a between blade 30a and inner rim 40, a second interface 62a between blade 30a and disc 50, and a third interface 64a between inner rim 40 and disc 50. Diffusion bonding may occur at one or more of first, second, and third interfaces 60a, 62a, 64a, respectively. In some embodiments, diffusion bonding may occur at all three interfaces, namely, first, second, and third interfaces 60a, 62a, 64a.

FIG. 3B is an enlarged axial view of a portion of a turbine rotor 12b showing an alternative blade tip configuration of a blade 30b in relation to disc 50 and inner rim 40, according to another embodiment of the invention. Each of inner rim 40, disc 50, and blade 30b may comprise various superalloy compositions and microstructures, generally as described for FIG. 3A. Turbine rotor 12b may have a first interface 60b between blade 30b and inner rim 40, a second interface 62b between blade 30b and disc 50, and a third interface 64b between inner rim 40 and disc 50. Diffusion bonding may occur at first, second, and third interfaces 60b, 62b, 64b, generally as described for FIG. 3A.

Again with reference to FIG. 3B, blade 30b may be tapered from broad to narrow in a radially outward direction from second blade tip 32b′/disc 50 and within inner rim 40. As a result, blade 30b may be coupled mechanically, as well as metallurgically, to inner rim 40 at first interface 60b. In addition, as a further result of the tapered configuration of blade 30b, first interface 60b between blade 30b and inner rim 40 may have an increased surface area, for example, as compared with first interface 60a (FIG. 3A). Furthermore, as a result of the tapered configuration of blade 30b, second interface 62b between blade 30b and disc 50 may also have an increased surface area, for example, as compared with second interface 62a (FIG. 3A). The increased surface area at first and second interfaces 60b, 62b may allow for increased diffusion bonding thereat.

FIG. 4 schematically represents a series of steps involved in a method 100 for providing a turbine rotor, according to another embodiment of the invention, wherein step 102 may involve forming a plurality of rotor blades. Each of the plurality of rotor blades may be individually cast by an investment casting process. Such casting processes for turbine components are well known in the art. Commonly assigned, co-pending US Patent Application Publication No. 20050025613, which discloses a process for casting an integral blade ring for a turbine rotor, is incorporated by reference herein in its entirety.

Each of the plurality of rotor blades formed in step 102 may comprise a single crystal nickel-based superalloy. Each of the individually cast rotor blades may be inspected, for example, using techniques such as macroscopic visual inspection, application of fluorescent penetrant, and X-ray diffraction, to identify any sub-standard rotor blades, which may be discarded prior to step 104. Such inspection techniques are well known in the art for inspecting airfoils and other turbine components.

During or after casting the rotor blades in step 102, oxide scale may form on the rotor blades. Accordingly, prior to step 104, any oxide scale may be removed from the surface of the rotor blades, e.g., using an acid, and thereafter the rotor blades may be cleaned, e.g., with surfactant and/or acid.

Step 104 may involve coating each of the rotor blades, over at least a portion of its surface, with an oxidation resistant coating, wherein the oxidation resistant coating may prevent formation of an oxide scale on the rotor blade surface. In the absence of such an oxidation resistant coating, oxide scale may be formed on the rotor blade surface prior to and during step 106 following exposure of the rotor blades to an oxidizing environment. The oxidation resistant coating applied in step 104 may comprise a platinum group metal, e.g., platinum, palladium, rhodium, ruthenium, osmium, and iridium, or a mixture thereof. The oxidation resistant coating may be applied to each rotor blade to a thickness sufficient to protect the rotor blade from oxidation and oxide scale formation thereon until such time as the rotor blades have been diffusion bonded to the blade ring (steps 106 and/or 108, infra). Furthermore, the oxidation resistant coating may be applied to each rotor blade to a thickness sufficiently thin such that at least about 50% of the oxidation resistant coating may dissipate by diffusion into other rotor components of the turbine rotor during steps 106, 108, and 114. The oxidation resistant coating may typically be applied to the rotor blades to a thickness of up to about 0.0030 inches (ca. 12 μm), and usually up to about 0.0015 inches (ca. 6 μm).

During step 104, the oxidation resistant coating may be applied to the surface of the rotor blades by various deposition techniques, such as one or more methods selected from: electroplating, chemical vapor deposition, and ion plating. In some embodiments, step 104 may involve applying the oxidation resistant coating sequentially in a series of layers. The various layers may have the same or different compositions, and may be applied using various deposition techniques, to form an oxidation resistant coating, having suitable thickness, adhesion to the superalloy rotor blade substrate, and composition, for preventing oxide scale formation on the coated rotor blades. Step 104 may involve applying the oxidation resistant coating to the entire surface of each rotor blade. In alternative embodiments, the oxidation resistant coating may be selectively applied to each rotor blade, for example, to one or both of first and second blade tips (see, for example, FIG. 2A), such that an intermediate portion of each rotor blade may remain uncoated.

Step 106 may involve bi-casting the individually cast, coated blades into an integral blade ring. The blade ring may include at least an inner rim. In some embodiments, the blade ring may further include an outer rim. The rotor blades may extend radially outward from the inner rim towards the outer rim. Each of the inner and outer rims may comprise a nickel- or cobalt-based superalloy. Each rotor blade may have a first blade tip disposed within the outer rim and a second blade tip disposed within the inner rim (see, for example, FIGS. 1A-B). During the bi-casting of step 106, the first and second blade tips may be diffusion bonded to the outer and inner rims, respectively. Diffusion bonding of the rotor blades to the outer and inner rims may take place in part during step 106, and in further part during a subsequent heat treatment procedure (e.g., step 108, infra).

Step 108 may comprise a heat treatment step in which the first and second blade tips may be further diffusion bonded to the outer and inner rims of the blade ring. As an example, step 108 may involve hot isostatic pressing (HIP) of the blade ring. Step 108 may be performed at a temperature typically in the range of from about 2000 to 2350° F., and at a pressure of from about 15 to 30 ksi for about 2 to 8 hours, and usually from about 2100 to 2300° F. at a pressure of from about 20 to 30 ksi for about 2 to 6 hours.

During diffusion bonding (e.g., step 108), constituents of the rotor blades may diffuse into the inner and outer rims, and vice versa, as is well known in the art. In addition, during step 108, at least a portion of the oxidation resistant coating may dissipate, for example, due to diffusion of constituents of the oxidation resistant coating from the coated blades into the inner and outer rims. Typically, during step 108 the proportion of the oxidation resistant coating that may diffuse into the inner and outer rims may be in the range of from about 50-100%, usually about 70-100%, and often about 80 to 100%.

Step 110 may involve providing an alloy disc for the blade ring. As a non-limiting example, the disc may be a powder metallurgy superalloy disc, such discs for turbine rotors being well known in the art. Alternatively, the disc provided in step 110 may be forged. A high temperature powder metallurgy superalloy is disclosed in commonly assigned, co-pending US Patent Application Publication No. 20050047953, the disclosure of which is incorporated by reference herein in its entirety.

Step 112 may involve match-machining the disc and the blade ring preparatory to diffusion bonding the disc to components of the blade ring during step 114. Step 114 may involve diffusion bonding components of the blade ring to the disc to form the turbine rotor. Thus, during step 114 the disc may be diffusion bonded to the rotor blades at the inner rim/disc interface, and the inner rim may be diffusion bonded to the disc at the blade/disc interface (see, for example, FIGS. 3A-B). Step 114 may involve a further heat treatment, such as hot isostatic pressing of the turbine rotor. Thus, during step 114, further diffusion bonding of the rotor blades to the inner and outer rims may occur.

Although the invention has been described primarily with respect to turbine components for aircraft gas turbine engines, the present invention may also find applications for making components for other types of apparatus and systems.

It should be understood, of course, that the foregoing relates to exemplary embodiments of the invention and that modifications may be made without departing from the spirit and scope of the invention as set forth in the following claims.

We claim:

1. A method for providing a turbine rotor, comprising the steps of:
a) forming a plurality of individual rotor blades;
b) forming an oxidation resistant coating on at least a portion of each of said rotor blades to provide a plurality of coated rotor blades; and
c) bi-casting said coated rotor blades into a blade ring.

2. The method of claim 1, wherein:
said oxidation resistant coating prevents formation of an oxide scale on a surface of said coated rotor blades, and
said coated rotor blades are diffusion bonded of to at least one of an inner rim and an outer rim of said blade ring.

3. The method of claim 1, wherein said step b) comprises applying said oxidation resistant coating to said rotor blades by at least one process selected from the group consisting of electroplating, chemical vapor deposition, and ion plating.

4. The method of claim 1, wherein said oxidation resistant coating comprises a platinum group metal.

5. The method of claim 1, wherein said oxidation resistant coating comprises at least one material selected from the group consisting of platinum, palladium, rhodium, ruthenium, osmium, and iridium.

6. The method of claim 1, wherein said step a) comprises casting single crystal rotor blades.

7. The method of claim 1, wherein:
said blade ring includes an inner rim, and
said step c) comprises bi-casting said rotor blades into said inner rim, wherein said rotor blades are diffusion bonded to said inner rim.

8. The method of claim 7, wherein:
said blade ring further includes an outer rim, and
said step c) further comprises bi-casting said rotor blades into said outer rim, wherein said rotor blades are diffusion bonded to said outer rim.

9. The method of claim 7, further comprising:
d) after said step c), hot isostatic pressing said blade ring, wherein said step d) provides further diffusion bonding of said coated rotor blades to said inner rim.

10. The method of claim 1, further comprising:
e) diffusion bonding at least one component of said blade ring to a disc to provide said turbine rotor.

11. The method of claim 10, wherein said step e) comprises diffusion bonding said rotor blades to said disc.

12. The method of claim 11, wherein said step e) further comprises diffusion bonding said disc to an inner rim of said blade ring.

13. The method of claim 11, wherein each of said rotor blades is tapered from broad to narrow in a radially outward direction from said disc.

14. The method of claim 12, wherein said inner rim comprises an equiaxed nickel-based or cobalt-based superalloy.

15. The method of claim 10, wherein said step e) comprises hot isostatic pressing said turbine rotor.

16. The method of claim 1, wherein:
said step a) comprises casting said plurality of rotor blades, and the method further comprises:
f) prior to said step b), eliminating any sub-standard castings formed during said step a).

17. The method of claim 1, wherein said rotor blades comprise a nickel-based superalloy.

18. The method of claim 1, wherein said rotor blades comprise single crystal nickel-based superalloy.

19. A method for providing a turbine rotor, comprising:
a) casting a plurality of individual rotor blades;
b) coating at least a portion of each of said rotor blades with an oxidation resistant coating to provide a plurality of coated blades;
c) bi-casting said coated blades into at least an inner rim to form an integral blade ring, wherein said step b) prevents formation of an oxide scale on a surface of said coated blades; and
d) diffusion bonding said coated blades to at least said inner rim.

20. The method of claim 19, wherein said step b) comprises coating the entire surface of each of said rotor blades with said oxidation resistant coating.

21. The method of claim 19, wherein:
said blade ring includes an outer rim, and
said step c) comprises bi-casting said coated blades into both said inner rim and said outer rim.

22. The method of claim 19, further comprising:
e) diffusion bonding at least one component of said blade ring to a disc to provide said turbine rotor.

23. The method of claim 22, wherein:
said step e) comprises diffusion bonding said rotor blades to said disc, and
each of said rotor blades comprises a nickel-based single crystal superalloy.

24. The method of claim 23, wherein said step e) further comprises diffusion bonding said disc to said inner rim of said blade ring.

25. The method of claim 19, wherein said disc comprises a powder metallurgy superalloy.

26. A method for bi-casting a multi-alloy turbine rotor, comprising:
a) casting a plurality of individual single crystal rotor blades;
b) coating at least a portion of a surface of each of said rotor blades with an oxidation resistant coating to provide a plurality of coated blades;
c) bi-casting said coated blades into an integral blade ring;
d) diffusion bonding said rotor blades to at least an inner rim of said blade ring;
e) match-machining said blade ring and an alloy disc; and
f) diffusion bonding said blade ring to said disc to provide said multi-alloy turbine rotor, wherein:
prior to and during said step c), said oxidation resistant coating prevents formation of an oxide scale on said surface of said coated blades,
said oxidation resistant coating allows said diffusion bonding of said coated blades to at least said inner rim of said blade ring, and
said oxidation resistant coating comprises a platinum group metal.

27. The method of claim 26, wherein
said step b) comprises coating at least one of a first tip and a second tip of each of said rotor blades with said oxidation resistant coating, and
an intermediate portion of each of said rotor blades remains uncoated.

28. The method of claim 26, wherein said step d) comprises diffusion bonding said rotor blades to said inner rim by hot isostatic pressing.

29. The method of claim 26, wherein said oxidation resistant coating comprises platinum or a platinum alloy.

30. The method of claim 26, wherein said step f) comprises diffusion bonding said rotor blades to said disc.

31. The method of claim 26, wherein said step f) is performed by hot isostatic pressing.

32. A method for bi-casting a multi-alloy turbine rotor, comprising:
a) casting a plurality of individual single crystal rotor blades from a nickel-based superalloy;
b) coating at least a portion of a surface of each of said rotor blades with an oxidation resistant coating to provide a plurality of coated blades, wherein said oxidation resistant coating comprises at least one material selected from the group consisting of platinum, palladium, rhodium, ruthenium, osmium, and iridium;
c) bi-casting said coated blades into at least an inner rim to provide a blade ring;
d) diffusion bonding said coated blades to said blade ring by hot isostatic pressing, wherein:
prior to and during said step c), said oxidation resistant coating prevents formation of an oxide scale on said surface of said coated blades, thereby allowing said diffusion bonding of said coated blades to at least said inner rim of said blade ring;
e) providing an alloy disc;
f) match-machining said blade ring and said disc; and
g) diffusion bonding said rotor blades and said inner rim to said disc by hot isostatic pressing to provide said multi-alloy turbine rotor, wherein:
said step d) comprises diffusion bonding said rotor blades to said inner rim, and
during at least one of said steps d) and g), at least a portion of said oxidation resistant coating diffuses into at least one component selected from: said rotor blades, said inner rim, and said disc.

33. The method of claim 32, wherein said step b) comprises applying said oxidation resistant coating to said rotor blades by electroplating.

34. The method of claim 32, wherein, during at least one of said steps d) and g), from about 70% to 100% of said oxidation resistant coating diffuses into at least one component selected from: said rotor blades, said inner rim, and said disc.

35. The method of claim 32, wherein:
said inner rim comprises an equiaxed nickel-based or cobalt-based superalloy, and
said step e) comprises providing a powder metallurgy superalloy disc.

36. A turbine rotor prepared by a process comprising:
a) casting a plurality of individual single crystal rotor blades;
b) coating at least a portion of the surface of each of said rotor blades with an oxidation resistant coating to provide a plurality of coated blades;
c) bi-casting said coated blades into a blade ring comprising an inner rim;
d) diffusion bonding said rotor blades to said inner rim of said blade ring; and
e) diffusion bonding said blade ring to an alloy disc to provide said turbine rotor.

37. The turbine rotor of claim 36, wherein:
said rotor blades comprise a first alloy comprising a nickel-based superalloy,
said inner rim comprises a second alloy comprising an equiaxed cobalt-based or nickel-based superalloy,
said disc comprises a third alloy comprising a powder metallurgy superalloy, and
said oxidation resistant coating comprises at least one material selected from the group consisting of platinum, palladium, rhodium, ruthenium, osmium, and iridium.

38. The turbine rotor prepared according to the method of claim 1.

39. The turbine rotor prepared according to the method of claim 26.
